(19) United States
(12) Patent Application Publication
(10) Pub. No.: US 2003/0101215 A1
(43) Pub. Date: May 29, 2003

(54) Method for using sub-stimuli to reduce audio distortion in digitally generated stimuli during a hearing test

(76) Inventors: Sunil Puria, Mountain View, CA (US); Ephram Cohen, San Francisco, CA (US); Benny B. Johansen, Sunnyvale, CA (US)

Correspondence Address: HAYNES BEFFEL & WOLFELD LLP, P O BOX 366, HALF MOON BAY, CA, 94019, US

(21) Appl. No.: 09/996,161

(22) Filed: Nov. 27, 2001

(51) Int. Cl. G06F 15/16

(52) U.S. Cl. 709/203

(57) ABSTRACT

A method of testing the hearing of a user utilizing a computer system that includes a computer and a speaker. The computer can output an electrical signal to the speaker and the speaker can convert the electrical signal into a stimulus. The method includes: downloading a computer program from a server to the computer; executing the computer program on the computer; generating a digital stimulus, the stimulus having a first sub-stimulus and a second sub-stimulus, the first sub-stimulus being within the audible range of humans, the second sub-stimulus being outside of the audible range of humans and/or outside of the range of the hearing test; and receiving an input from the user that indicates that the user heard the stimulus. The purpose of the sub-stimuli is to dither the stimuli so as to minimize distortions due to quantization of the stimuli and thus improve hearing test accuracy.

### 1. FIELD OF THE INVENTION

The present invention generally relates to audiology and presentation of audio signals for assessing a person's hearing using a personal computer. More specifically, the present invention relates to a system and a method for reducing audio distortion in stimuli during a hearing test.

### 2. BACKGROUND

Audiometric equipment exists for testing hearing. However, such equipment is expensive and is generally available only in hearing clinics. Many people are reluctant to visit hearing clinics and take a hearing test for a variety of reasons. Such reasons may include the cost of a hearing test, the time and inconvenience involved in scheduling of an appointment, waiting for and undergoing a hearing test, and privacy concerns. As a result, as many as 80 percent of the people who suffer from hearing loss in the United States may have not had their hearing tested.

Currently, a number of companies provide hearing tests over the Internet. For example, a user may have his/her hearing tested by accessing one of the following URLs: www.didvouhearme.com, www.handtronix.com, www.onlinehearing.com, www.audiainc.com, www.NigelWorks.com, www.audiologyawareness.com or www.freehearingtest.com.

For example, when a user accesses www.didyouhearme.com's hearing test, the user's computer system outputs a 500 Hz tone to a speaker, such as a powered or un-powered speaker or headphone that may include piezo electric transducers, which is coupled to the computer system. Next, the website instructs the user to decrease the volume on the user's computer until the user can no longer hear the 500 Hz tone.

Next, the website generates a 4000 Hz tone. According to the website, if the user cannot hear the 4000 Hz tone, the user may have a hearing impairment. Next, the website generates a number of tones at different amplitudes at the following frequencies: 250, 500, 750, 1000, 1500, 2000, 3000, and 4000 Hz. When the user hears a particular frequency, the user presses an acknowledge button on the screen with the computer's mouse. Based upon the user's acknowledgements, the website generates an audiogram. An audiogram is a chart plotting a user's hearing threshold level in dB HL as a function of frequency. Using the audiogram, the user can determine if the user has a hearing impairment and in some cases the etiology of the impairment can be determined.

Unfortunately, when a computer system generates small amplitude digital stimuli, such as soft and/or high frequency stimuli, the limited number of bits utilized by the computer sound generating mechanisms to output these stimuli may induce quantization errors. Quantization errors can modify the spectral characteristics of the stimuli and can degrade the accuracy of the hearing test. For example, in some cases, a user may hear harmonic distortion that results from quantization errors rather than the intended probe stimuli. This can happen because the threshold of hearing at the harmonic frequencies can be lower than the threshold of hearing at the intended probe frequency. In such cases, the user may mistakenly indicate that the user hears the probe stimuli. Thus, accuracy of the hearing test will be substantially degraded.

Therefore, a need exists for a hearing test that avoids such quantization errors when outputting small amplitude stimuli.

### 3. SUMMARY OF THE INVENTION

One embodiment of the invention is a method of testing the hearing of a user utilizing a computer system that includes a computer equipped with a sound card and a speaker. The computer can output a digital signal to the sound card, which in turn can output an electrical signal to the speaker and the speaker can convert the electrical signal into a stimulus. The method includes: downloading a computer program from a server to the computer; executing the computer program on the computer; generating a stimulus, the stimulus having a first sub-stimulus and a second sub-stimulus, the first sub-stimulus being within the audible range of humans, the second sub-stimulus being outside of the audible range of humans and/or outside of the range of the hearing test; and receiving an input from the user that indicates that the user heard the stimulus. In some embodiments of the invention, the method also includes: sending data to the server; qualifying the hearing of the user; and sending other data to the computer.

Still other embodiments of the invention include program storage devices that contain computer readable instructions that, when executed, perform portions of the above methods.

### 4. BRIEF DESCRIPTION OF THE FIGURES

FIG. 1 presents a method of testing the hearing of a user that includes utilizing a stimulus that includes two sub-stimuli.

FIG. 2 presents a high-level sub-stimulus at 1 kHz.

FIG. 3 presents the high-level sub-stimulus of FIG. 2 summed with a second sub-stimulus.

FIG. 4 presents a low-level sub-stimulus at 1 kHz.

FIG. 5 presents the low-level sub-stimulus of FIG. 4 summed with a second sub-stimulus.

### 5. DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

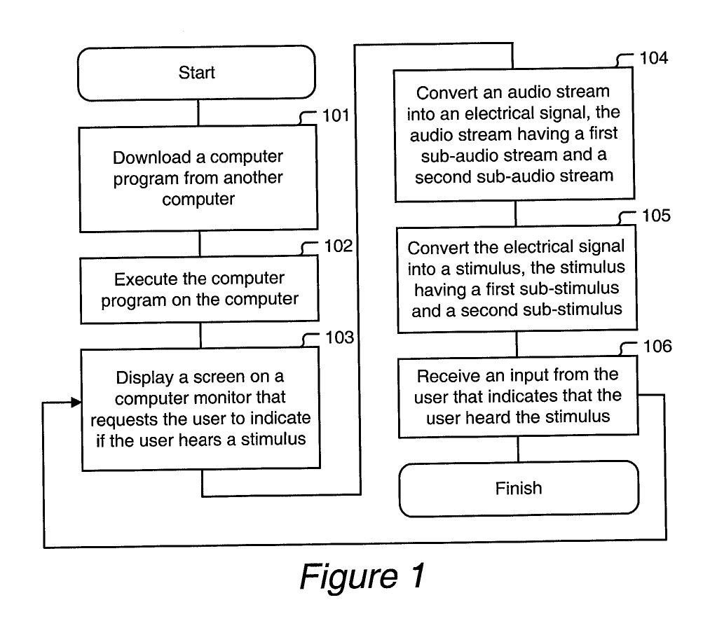

One embodiment of the invention, a method of testing the hearing of a user utilizing a computer system, is shown in FIG. 1. The method can be performed on a conventional computer system, such as a desktop computer system, a laptop computer system, or a handheld computer system.

5.1 Method of Utilizing Sub-Stimuli to Reduce Audio Distortion in Digitally Generated Stimuli

One embodiment of the invention, which is shown in FIG. 1, is a method of testing the hearing of a user utilizing a computer system. This method generates a stimulus that contains two sub-stimuli. The first sub-stimulus is the stimulus that the user is intended to hear, i.e., the probe stimulus. This sub-stimulus is within the audible range of humans. The second sub-stimulus is not intended to be detected by the user. However, by including the second sub-stimulus, quantization errors and harmonic distortion that could result from outputting the first sub-stimuli alone are reduced by design.

In some cases, the second sub-stimulus may be outside of the audible range of humans. Alternatively or in addition, the second sub-stimulus may be outside of the desired frequency and/or amplitude range of the hearing test. For example, if a hearing test generates Warble tones between 250 Hz and 4000 Hz, then the “frequency range” of that hearing test is approximately 225 Hz (0.9*250 Hz) to 4400 Hz (1.1*4000 Hz). Thus, in some embodiments of the invention, the second sub-stimulus could have frequency content that is less than 225 Hz or greater than 4400 Hz, i.e., outside of the frequency range of the hearing test. Similarly, the second sub-stimulus could have frequency content that is outside of the “amplitude range” of the hearing test.

Referring to Block 101 of FIG. 1, a user that desires to take a hearing test first downloads a computer program, such as a stand-alone executable program, a Java applet, an Active X control, or a Netscape plugin, from another computer, such as a server, to his/her computer. In one embodiment of the invention, the computer program is transferred via the Internet. In another embodiment of the invention, the computer program is transferred via an email. As is well known, computer programs may be attached to emails that can be easily distributed over the Internet, virtual private networks, local area networks and/or wide area networks. In still other embodiments, the computer program could be transferred to the user via the United States postal service or other postal service.

Next, referring to Block 102 of FIG. 1, the user executes the computer program on a computer. Then, referring to Block 103 of FIG. 1, the computer program displays a screen on the computer monitor that requests the user to indicate if the user hears a stimulus. Next, referring to Block 104 of FIG. 1, the computer program converts an audio stream, i.e., digital data that represents an audio signal, into an electrical signal. The audio stream would include a first sub-audio stream and a second sub-audio stream.

The first sub-audio stream would include digital data that represents the probe stimulus, such as a Warble tone and a predetermined amplitude. As discussed above, the probe stimulus is typically within the audible range of humans.

The second sub-audio stream would include digital data that is not intended to be detected by the user. For example, the second sub-audio stream may include a single-bit dithering signal, a multi-bit dithering signal, a pure tone, white noise, and/or pink noise. Alternatively or in addition to, the second sub-audio stream may include digital data that is outside of the range of the hearing test. The purpose of the second sub-audio stream is to reduce quantization errors that may occur if the first sub-audio stream were converted from a floating-point representation into a stimulus with integer representation without being combined with the second audio-stream. By summing both sub-audio streams before integer quantization, the quantization errors in the audio stream are minimized by design resulting in harmonic distortions that are significantly reduced.

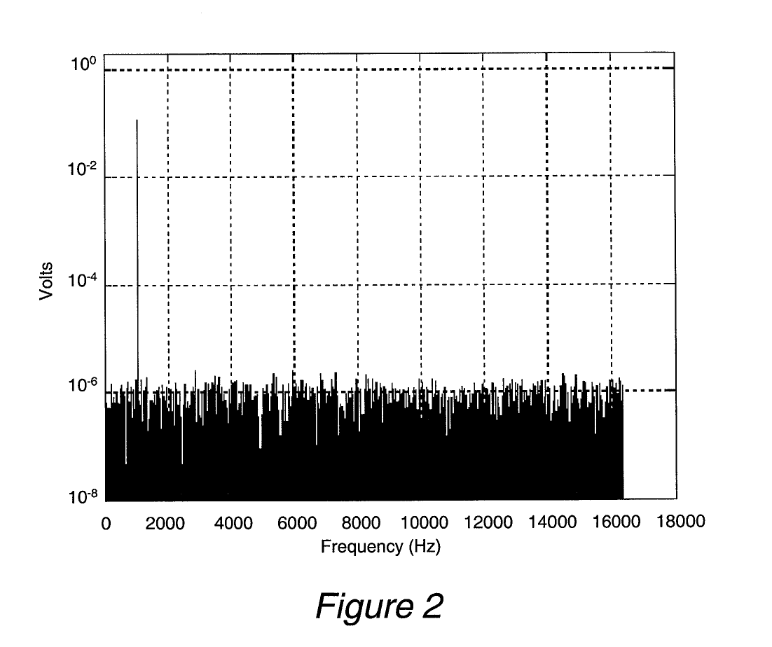

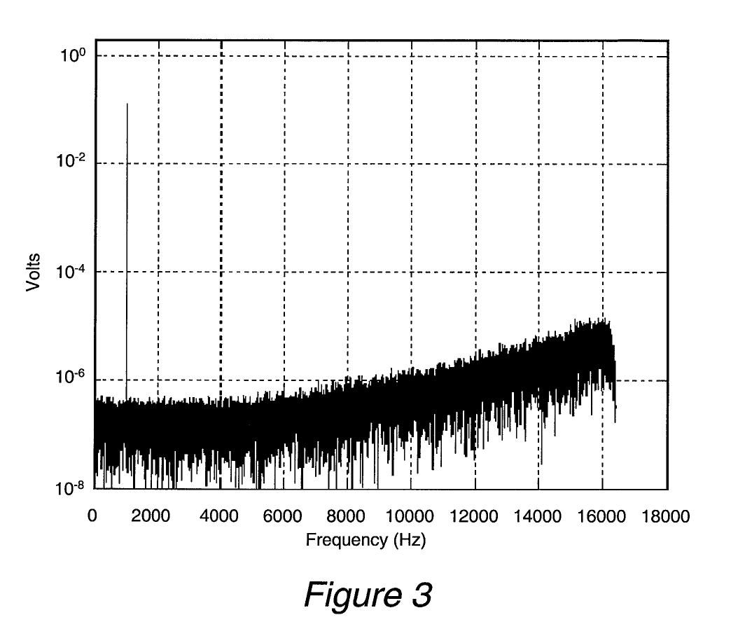

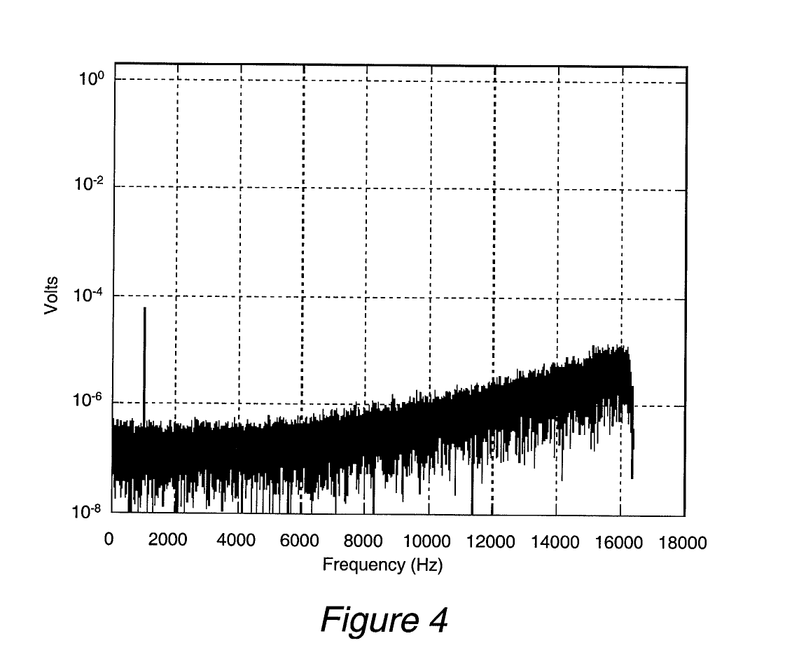

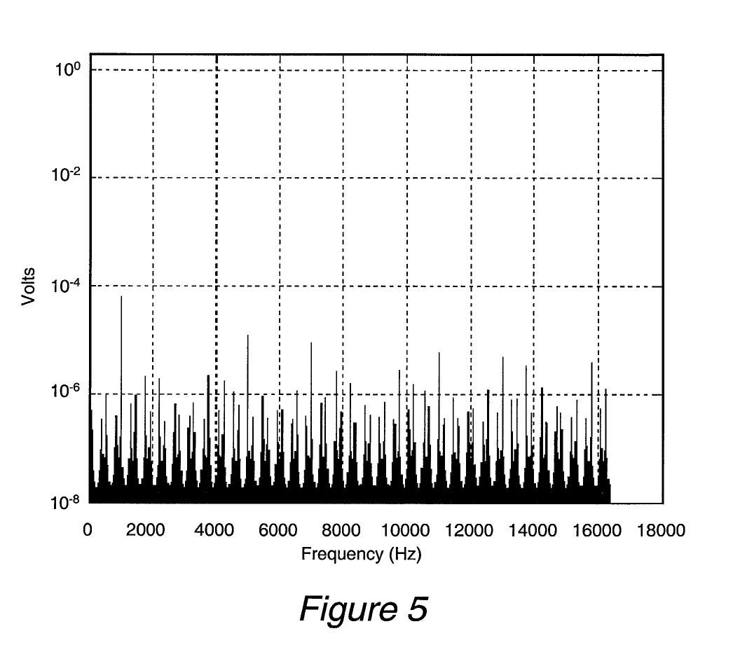

FIG. 2 presents a high-level sub-stimulus at 1 kHz. FIG. 3, presents the same high-level sub-stimulus summed with a second sub-stimulus. As a result of the addition of the second sub-stimulus, the noise floor has been reduced. FIG. 4 presents a low-level sub-stimulus at 1 kHz. FIG. 5 presents the same low-level sub-stimulus summed with a second sub-stimulus. As a result of the addition of the second sub-stimulus before quantization, the noise floor has also been reduced.

Next, referring to Block 105 of FIG. 1, the speaker converts the electrical signal into a stimulus. The stimulus includes two sub-stimuli. The first sub-stimulus is typically within the audible range of humans. The second sub-stimulus is typically outside of the audible range of humans and/or outside of the range of the hearing test.

Next, if the user hears the stimulus, then the user inputs information into the computer that indicates that the user hears the stimulus. Referring to block 106 of FIG. 1, the computer program then receives the input from the user that indicates that the user heard the stimulus.

As shown in FIG. 1, by repeating Blocks 103 through 106 with stimuli of different amplitudes and frequencies, data sufficient to quantify the hearing of the user can be derived using conventional methods. In some embodiments of the invention, the computer program qualifies the hearing. In other embodiments, the computer program transfers data to a server and the server qualifies the hearing and then sends data back to the computer program. After the hearing of the user is quantified, some embodiments of the invention present an audiogram, text information, and/or graphical information to the user.

### 5.2 CONCLUSION

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. For example, program storage devices, such as hard disks, floppy disks, random access memories (RAM), read only memories (ROM), programmable read only memories (PROM), compact disks (CD), and digital versatile disks that contain computer readable instructions that perform portions of the above methods, are intended to be included in the present invention. Additionally, the above disclosure is not intended to limit the present invention. The scope of the present invention is defined by the appended claims.

It is claimed:

1. A method of testing the hearing of a user utilizing a computer system, the computer system including a computer and a speaker, the computer operable to generate an electrical signal and then to output the electrical signal to the speaker, the speaker operable to convert the electrical signal into a stimulus, the method comprising:
a) downloading a computer program from a server to the computer;
b) executing the computer program on the computer;
c) generating a stimulus, the stimulus having a first sub-stimulus and a second sub-stimulus, the first sub-stimulus being within the audible range of humans, the second sub-stimulus being outside of the audible range of humans; and
d) receiving an input from the user that indicates that the user heard the stimulus.

2. The method of claim 1, wherein the act of downloading the computer program includes transferring the computer program from the server to the computer via the Internet.

3. The method of claim 1, wherein the act of downloading the computer program includes transferring the computer program from the server to the computer via an email.

4. The method of claim 1, wherein the act of generating a stimulus includes generating a stimulus from an audio stream that utilizes a larger number of bits to represent the stimulus than would be utilized to represent the first sub-stimulus.

5. The method of claim 1, wherein the act of generating a stimulus includes generating a stimulus having a first sub-stimulus and a second sub-stimulus, the first sub-stimulus having an amplitude that is smaller than the amplitude of the second sub-stimulus.

6. The method of claim 1, wherein the act of generating a stimulus includes generating a stimulus having a first sub-stimulus and a second sub-stimulus, wherein the first sub-stimulus includes a Warble tone.

7. The method of claim 1, wherein the act of generating a stimulus includes generating a stimulus having a first sub-stimulus and a second sub-stimulus, wherein the second sub-stimulus includes a dithering signal.

8. The method of claim 1, wherein the act of generating a stimulus includes generating a stimulus having a first sub-stimulus and a second sub-stimulus, wherein the second sub-stimulus includes white noise.

9. The method of claim 1, wherein the act of generating a stimulus includes generating a stimulus having a first sub-stimulus and a second sub-stimulus, wherein the second sub-stimulus includes pink noise.

10. The method of claim 1, further including:
e) sending first data to the server;
f) qualifying the hearing of the user; and
g) sending second data to the computer.

11. A method of testing the hearing of a user utilizing a computer system, the computer system including a computer and a speaker, the computer operable to output an electrical signal to the speaker, the speaker operable to convert the electrical signal into a stimulus, the method comprising:
a) downloading a computer program from a server to the computer;
b) executing the computer program on the computer;
c) generating a stimulus, the stimulus having a first sub-stimulus and a second sub-stimulus, the first sub-stimulus being within the audible range of humans, the second sub-stimulus being outside of the frequency range of the hearing test; and
d) receiving an input from the user that indicates that the user heard the stimulus.

12. The method of claim 11, wherein the act of downloading the computer program includes transferring the computer program from the server to the computer via the Internet.

13. The method of claim 11, wherein the act of downloading the computer program includes transferring the computer program from the server to the computer via an email.

14. The method of claim 11, wherein the act of generating a stimulus includes generating a stimulus from an audio stream that utilizes a larger number of bits to represent the stimulus than would be utilized to represent the first sub-stimulus.

15. The method of claim 11, wherein the act of generating a stimulus includes generating a stimulus having a first sub-stimulus and a second sub-stimulus, the first sub-stimulus having an amplitude that is smaller than the amplitude of the second sub-stimulus.

16. The method of claim 11, wherein the act of generating a stimulus includes generating a stimulus having a first sub-stimulus and a second sub-stimulus, wherein the first sub-stimulus includes a Warble tone.

17. The method of claim 11, wherein the act of generating a stimulus includes generating a stimulus having a first sub-stimulus and a second sub-stimulus, wherein the second sub-stimulus includes a dithering signal.

18. The method of claim 11, wherein the act of generating a stimulus includes generating a stimulus having a first sub-stimulus and a second sub-stimulus, wherein the second sub-stimulus includes white noise.

19. The method of claim 11, wherein the act of generating a stimulus includes generating a stimulus having a first sub-stimulus and a second sub-stimulus, wherein the second sub-stimulus includes pink noise.

20. The method of claim 11, further including:
e) sending first data to the server;
f) qualifying the hearing of the user; and
g) sending second data to the computer.

21. A program storage device that contains computer readable instructions that, when executed by a computer system having a volume control, tests the hearing of a user by:
a) setting the volume control of the computer;
b) generating a stimulus, the stimulus having a first sub-stimulus and a second sub-stimulus, the first sub-stimulus being within the audible range of humans, the second sub-stimulus being outside of the audible range of humans; and
c) receiving an input from the user that indicates that the user heard the stimulus.

22. The program storage device of claim 21, wherein the act of generating a stimulus includes generating a stimulus having a first sub-stimulus and a second sub-stimulus, the first sub-stimulus having an amplitude that is smaller than the amplitude of the second sub-stimulus.

23. The program storage device of claim 21, wherein the act of generating a stimulus includes generating a stimulus having a first sub-stimulus and a second sub-stimulus, wherein the first sub-stimulus includes a Warble tone.

24. The program storage device of claim 21, wherein the act of generating a stimulus includes generating a stimulus having a first sub-stimulus and a second sub-stimulus, wherein the second sub-stimulus includes a dithering signal.

25. The program storage device of claim 21, wherein the act of generating a stimulus includes generating a stimulus having a first sub-stimulus and a second sub-stimulus, wherein the second sub-stimulus includes white noise.

26. The program storage device of claim 21, wherein the act of generating a stimulus includes generating a stimulus having a first sub-stimulus and a second sub-stimulus, wherein the second sub-stimulus includes pink noise.

27. A program storage device that contains computer readable instructions that, when executed by a computer system having a volume control, tests the hearing of a user by:
a) setting the volume control of the computer;
b) generating a stimulus, the stimulus having a first sub-stimulus and a second substimulus, the first sub-stimulus being within the audible range of humans, the second sub-stimulus being outside of the range of the hearing test; and
c) receiving an input from the user that indicates that the user heard the stimulus.

28. The program storage device of claim 27, wherein the act of generating a stimulus includes generating a stimulus from an audio stream that utilizes a larger number of bits to represent the stimulus than would be utilized to represent the first sub-stimulus.

29. The program storage device of claim 27, wherein the act of generating a stimulus includes generating a stimulus having a first sub-stimulus and a second sub-stimulus, the first sub-stimulus having an amplitude that is smaller than the amplitude of the second sub-stimulus.

30. The program storage device of claim 27, wherein the act of generating a stimulus includes generating a stimulus having a first sub-stimulus and a second sub-stimulus, wherein the first sub-stimulus includes a Warble tone.

31. The program storage device of claim 27, wherein the act of generating a stimulus includes generating a stimulus having a first sub-stimulus and a second sub-stimulus, wherein the second sub-stimulus includes a dithered signal.

32. The program storage device of claim 27, wherein the act of generating a stimulus includes generating a stimulus having a first sub-stimulus and a second sub-stimulus, wherein the second sub-stimulus includes white noise.

33. The program storage device of claim 27, wherein the act of generating a stimulus includes generating a stimulus having a first sub-stimulus and a second sub-stimulus, wherein the second sub-stimulus includes pink noise.
